(19) United States
(12) Patent Application Publication
(10) Pub. No.: US 2002/0152251 A1
(43) Pub. Date: Oct. 17, 2002

(54) Low power CSD linear phase FIR filter architecture using virtual common subexpression and filter design method therefor

(75) Inventor: Young-Beom Jang, Seoul (KR)

Correspondence Address: Frank Chau, Esq., F. CHAU & ASSOCIATES, LLP, 1900 Hempstead Turnpike, East Meadow, NY, 11554, US

(73) Assignee: Samsung Electronics Co., Ltd.

(21) Appl. No.: 10/075,643

(22) Filed: Feb. 13, 2002

(30) Foreign Application Priority Data
Feb. 13, 2001 (KR) 2001-6901

(51) Int. Cl. G06F 17/10

(52) U.S. Cl. 708/319

(57) ABSTRACT

An apparatus and method for digital filtering includes a method for implementing a digital filter having filter coefficients, each expressible as a canonical signed digit code word; where the method includes forming a virtual common subexpression that is relevant to a first filter coefficient, forming a second subexpression for a second filter coefficient in terms of the virtual common subexpression so that adders are shared with the virtual common subexpression in a tap line of the second filter coefficients; and the resulting digital filter receives digital samples of input signals, shifts the received digital samples by bit-shift values of filter coefficients that are defined relative to the virtual common subexpression, adds shifted digital samples to drive a common tap line, adds shifted digital samples to the output of the common tap line to drive a tap line corresponding to a filter coefficient, and delays an output signal component corresponding to a tap line.

### BACKGROUND OF THE INVENTION

1. Field of the Invention

The present disclosure relates to digital filters, and more particularly, to low-power canonical signed digit (“CSD”) filter architectures using common subexpressions.

2. Description of the Related Art

Digital filters are typically made by forming, in a semiconductor substrate, circuits including multipliers, adders and delay devices. Filter coefficients, input signals and output signals of the digital filters are generally expressed as 2's complements. For high-speed and low-power filters that are required in intermediate frequency (“IF”) down-converter chips, such as, for example, those used in terminals for mobile radio communication systems and/or cellular phone systems, multiplication is typically performed with only adders and not multipliers.

The digital filters that are designed with such adders and delay devices without multipliers typically employ a canonical signed digit (“CSD”) type of expression, rather than a 2′ complement type of expression. The reason is that when any filter coefficients are expressed as binary digits, the CSD type is less than the 2′ complement in the number of “1” digits used therein. However, the CSD type of expression differs from the 2's complement in that the CSD type employs both the numerals “1” and “−1”. In the CSD type, adders are used when “1” is employed and subtracters are used when “−1” is used. In these cases, the costs for designing “1” and “−1” are generally the same.

Generally, the number of “1” numerals or the number of “−1” numerals that are used in the filter is the same as the number of adders or subtracters, respectively. That is, if the total number of “1” or “−1 ” numerals is m in a filter, (m−1) adders or subtracters are needed to implement the filter. For example, if m=24, 23 adders are needed.

However, CSD type filters may share a common subexpression, thereby decreasing the number of adders. When a linear phase finite impulse response (“FIR”) filter has 8 coefficients, the coefficients h0˜h3 are symmetric to the coefficients h7˜h4, respectively. Thus, the linear phase FIR filter has more common subexpressions than a typical FIR filter.

Three examples for designing FIR filters will be explained hereinafter by using common subexpressions that are created in symmetric filter coefficients. First, the following linear phase FIR filter of 14 taps is considered:

H(z)=h₀+h₁z⁻¹+h₂z⁻²+h₃z⁻³+h₄z⁻⁴+h₅z⁻⁵+h₆z⁻⁶+h₇z⁻⁸h₈z⁻⁸+h₉z⁻⁹+h₁₀z^{-z}+h₁₁z⁻¹¹+h₁₂z⁻¹²h₁₃z⁻¹³

If the above filter coefficients are expressed as the CSD type of Table 1, the numeral “−1” is indicated as “N”.

TABLE 1

| | −1 | −2 | −3 | −4 | −5 | −6 | −7 | −8 | −9 |
|---|---|---|---|---|---|---|---|---|---|
| h0 | | 1 | | | N | | | 1 | |
| h1 | | 1 | | | N | | | | 1 |
| h2 | | 1 | | | N | | 1 | | |
| h3 | | 1 | | | | N | | 1 | |
| h4 | | 1 | | N | | | | 1 | |
| h5 | | | 1 | | N | | | 1 | |
| h6 | 1 | | | | N | | | 1 | |

In Table 1, “0” is not shown but left blanked and the coefficients of h7 through h13 are omitted because the coefficients are symmetric to the coefficients of h0 through h6. The transverse directions indicate CSD type filter coefficients that are expressed with 9 “bits” and the columns indicate filter coefficients, respectively. That is, the filter coefficient of h0 is 0100N0010, which is a CSD type of coefficient. In Table 1, the transverse direction indicates shifting and column direction indicates delay. The first row and first column having a non-zero numeral or coefficient is defined by ×1 as a reference point.

The respective coefficient subexpressions are indicated by the following mathematical formulas:

h₀:x₂=x₁−x₁>>3+x₁>>6

h₁:x₃=x₁−x₁>>3+x₁>>7

h₂:x₄=x₁−x₁>>3+x₁>>5

h₃:x₅=x₁−x₁>>4+x₁>>6

h₄:x₆=x₁−x₁>>2+x₁>>6

h₅:x₇=x₁>>1−x₁>>3+x₁>>6

h₆:x₈=x₁>>(−1)−x₁>>3+x₁>>6

In the above formula, the symbol “>>” indicates “shift”. For instance, in the expression “h₀:x₂=x₁−x₁>>3+x₁>>6”, −x₁>>3 means shift of 3 bits an >>6 means shift of 6 bits when x1 is a reference point. Here, the “x1” itself means a shift of 1 bit. Accordingly, the shifted total numbers of bits are −1, −(−4) and −7, respectively. In the same manner, h₁:x₃=x₁−x₁>>3+x₁>>7 is indicated as −1,−(−4),−8. The “−(−4)” means “+4”, which, as is indicated by N in the Table 1, requires subtracters for calculation. The output signal is expressed by the following equation using the above subexpressions:

y=x₂>>1+x₃[−1]>>1+x₄[−2]>>1+x₅[−3]>>1+x₆[−4]>>1+x₇[−5]>>1+symmetry

After all, an output can be expressed as the sum of various input signals “x”s that are shifted and delayed. The “symmetry”, which is used here as a simple symbol, means that symmetric coefficients are repeated. That is, the coefficients of h7 through h13 are omitted and expressed by the term “symmetry” because they are symmetric relative to the coefficients of h6 through h0, respectively. If the FIR filter having coefficient subexpressions such as described above is designed by using a transposed direct form, the configuration shown in FIG. 1 is obtained.

In FIG. 1, the lines T1˜T7 indicate taps, the adders are indicated as the symbols Ai (i indicate natural numbers more than 0), the delayers Di, the input signal x, and the output signal y, respectively. In the figure, the subtracter for performing subtraction is expressed by an adder, but the input terminal of the subtracter is designated by the symbol “−”. It should be noted that the term “adder” that is used in the present specification includes the addition function for performing positive addition as well as the same function as a subtracter for performing negative addition or subtraction.

Referring to FIG. 1, the adders A1 and A2 shown in the tap line T1 perform additions of −1, −4, −7 and implement the coefficient h0, and the adders A3 and A4 shown in the tap line T2 perform additions of −1, −4, −8 and implement the coefficient h1. The figures-n (where n is an integer) such as “−1, −4, −8” mean 2−n and indicate an n-bit right shift operation. Thus, the input signal x is multiplied with −1, −4 and −8 by a shift register before the addition operation is performed. The “−n” shown in FIG. 1 is implemented by shift register hardware.

The delayers D1 to D13 delay the outputs of the corresponding adders by a predetermined time in order to obtain the output signal y. The reason that the coefficient h0 is designed with −1, −4, −7 is that the x1 should be designed by performing a shift of −1 once more than in the design formula since the x1 itself as a reference point includes a shift of −1.

The number of adders that are used to implement the filter shown in FIG. 1 is as follows: First, 14 adders A1 through A14 are needed to obtain each of the filter coefficients because the total number of filter coefficients is 7 and two adders per one filter coefficient are used. In addition, 13 adders A15 through A27 are needed to obtain the output signal. Accordingly, the total number of adders is 14+13=27.

As shown in Table 1, even though the subexpression of h0 is similar to that of the other coefficients, they are not a common subexpression and the number of additions cannot be reduced by conventional methods. Only when a method for decreasing the number of additions is obtained in such a subexpression can a low-power and high-speed filter can be designed from the CSD type filter.

As described above, the adders in the filter configuration shown in FIG. 1 can be somewhat reduced in number by using a common subexpression that is created using symmetry of filter coefficients. However, there remains a problem that a relatively large number of adders are still needed in the configuration.

As a second case, consideration of a linear phase FIR filter of 10 taps is as follows:

H(z)=h₀+h₁z⁻¹+h₂z⁻²+h₃z⁻³+h₄z⁻⁴+h₅z⁻⁵+h₆z⁻⁶+h₇z⁻⁸h₈z⁻⁸+h₉z⁻⁹

If the coefficients of the above filters are designated as a CSD type such as shown in Table 2, the numeral “−” is indicated by N as follows:

TABLE 2

| | −1 | −2 | −3 | −4 | −5 | −6 | −7 | −8 | −9 |
|---|---|---|---|---|---|---|---|---|---|
| H0 | 1 | | N | | | 1 | | N | |
| H1 | | | N | | | 1 | | N | |
| H2 | 1 | | | | | 1 | | N | |
| H3 | 1 | | N | | | | | N | |
| H4 | 1 | | N | | | 1 | | | |

In Table 2, “0” is left blanked and the coefficients of h5 through h9 are omitted because the coefficients are symmetric to the coefficients of h0 through h4. The row directions indicate CSD type filter coefficients that are expressed with 9 bits and the columns indicate filter coefficients, respectively. That is, the filter coefficient of h0 is 01 N0010N0, which is a CSD type of coefficient. In Table 2, the row direction indicates shifting and the column direction indicates delay. The first row and first column are defined by x1 as a reference point.

The respective coefficient subexpressions are indicated by the following mathematical formulas:

h₀:x₂=x₁−x₁>>2+x₁>>5−x₁>>7

h₁:x₃=−x₁>>2+x₁>>5−x₁>>7

h₂:X₄=x₁+x₁>>5−x₁>>7

h₃:x₅=x₁−x₁>>2−x₁>>7

h₄:x₆=x₁−x₁>>2+x₁>>5

The output signal can be expressed by using the above subexpression as follows:

y=x₂+x₃[−1]+x4[−2]+x₅[−3]+x₆[−4]+ symmetry

If the FIR filter having coefficient subexpressions such as described above is designed by using a transposed direct form, the configuration shown in FIG. 2 is obtained.

In FIG. 2, the lines T1˜T5 indicate taps like in FIG. 1, the adders are indicated as the symbols Ai (i indicate natural numbers more than 0), the delayers Di, the input signal x, and the output signal y, respectively. In the drawing, a subtracter for performing subtraction is expressed by an adder, but the input terminal of the subtracter is designated by the symbol “−”.

Referring to FIG. 2, the adders A1, A2 and A3, shown in the tap line T1, perform additions of −1, −3, −6 and −8 to implement the coefficient h0; and the adders A4 and A5 shown in the tap line T2 perform additions of −3, −6 and −8 to implement the coefficient h1. The delayers D1 to D9 delay the outputs of the corresponding adders by a predetermined time in order to obtain the output signal y.

The number of adders that are used to design the filter shown in FIG. 2 is as follows: First, 11 adders A1 through A11 are needed to obtain the filter coefficients because the total numbers of filter coefficients each are 3, 2, 2, 2 and 2. In addition, 9 adders A12 through A20 are needed and connected to the delayers so that addition is performed to obtain the output. Accordingly, the total number of adders is 11+9=20.

As shown in Table 2, since the subexpression of h0 is similar to that of the other coefficients, but they cannot be a common subexpression, the number of additions cannot be reduced. Only when a method for decreasing the number of additions is obtained in such a subexpression can a low-power and high-speed filter be designed from the CSD type filter.

As described above, the adders in the filter configuration shown in FIG. 2 can be somewhat reduced in the number by using a common subexpression that is created using the symmetry of filter coefficients. However, there remains a problem that a relatively large number of adders are still needed in the resulting configuration.

As a third case, consideration is made of the following linear phase FIR filter of 10 taps:

H(z)=h₀+h₁z⁻¹+h₂z⁻²+h₃z⁻³+h₄z⁻⁴+h₅z⁻⁵+h₆z⁻⁶+h₇z⁻⁸h₈z⁻⁸+h₉z⁻⁹

If the coefficients of the above filters are designated as a CSD type such as in Table 3, the numeral “−1” is indicated by N.

TABLE 3

| | −1 | −2 | −3 | −4 | −5 | −6 | −7 | −8 | −9 |
|---|---|---|---|---|---|---|---|---|---|
| H0 | 1 | | N | | | 1 | | N | |
| H1 | N | | N | | | 1 | | N | |
| H2 | 1 | | 1 | | | 1 | | N | |
| H3 | 1 | | N | | | N | | N | |
| H4 | 1 | | N | | | 1 | | 1 | |

In Table 3, “0” is left blanked and the coefficients of h5 through h9 are omitted because the coefficients are symmetric to the coefficients of h0 through h4. The row directions indicate CSD type filter coefficients that are expressed with 9 bits and columns indicate filter coefficients, respectively. That is, the filter coefficient of h0 is 10 N0010 N0, which is a CSD type of coefficient. In Table 3, the row direction indicates shifting and column direction indicates delay. The first row and first column are defined by x1 as a reference point.

The respective coefficient subexpressions are indicated by the following mathematical formula:

h₀:x₂=x₁−x₁>>2+x₁>>5−x₁>>7

h₁:x₃=−x₁−x₁>>2+x₁>>5−x₁>>7

h₂:X₄=x₁+x₁>>2−x₁>>5−x₁>>7

h₃:x₅=x₁−x₁>>2−x₁>>5−x₁>>7

h₄:x₆=x₁−x₁>>2+x₁>>5+x₁>>7

An output signal can be expressed by using the above-subexpression as follows:

y=x₂+x₃[−1]+x₄[−2]+x₅[−3]+x₆[−4]+ symmetry

If the FIR filter having coefficient subexpressions such as described above is designed by using a transposed direct form, the configuration shown in FIG. 3 is obtained.

In FIG. 3, the lines T1 to T5 indicate taps like in FIG. 1 or FIG. 2, the adders are indicated as the symbols Ai (i indicate natural numbers more than 0, the delayers Di, the input signal x, and the output signal y, respectively. In the drawing, a subtracter for performing subtraction is expressed by an adder, but the input terminal of the subtracter is designated by the symbol “−”.

Referring to FIG. 3, the adders A1, A2 and A3 shown in the tap line T1 perform additions of −1, 3, −6, −8 and design the coefficient h0, and the adders A4, A5 and A6 shown in the tap line T2 perform additions of −1, −3, −6 and −8 to implement the coefficient h1. The delayers D1 to D9 delay the outputs of the corresponding adders by a predetermined time in order to obtain the output signal y.

The number of adders that are needed to design the filter shown in FIG. 3 is as follows:

First, 15 adders are needed to obtain each of the filter coefficients because each of 5 taps requires three adders to design each of the coefficients. In addition, 9 adders are needed and connected to the delayers so that addition operations are performed for the output. Accordingly, the total number of adders is 15+9=24.

As shown in Table 3, since the subexpression of h0 is similar to that of the other coefficients, but they cannot become a common subexpression, the number of additions cannot be reduced. Only when a method for decreasing the number of additions is obtained in such a subexpression can a low-power and high-speed filter be designed from the CSD type filter.

The adders in the filter configuration shown in FIG. 3 can be somewhat reduced in number by using a common subexpression that is created from symmetry of filter coefficients. However, there remains a problem that a relatively large number of adders are still needed in the configuration.

In the linear phase FIR filters as described above, the number of adders is reduced by using common subexpressions that are created by the symmetry of the coefficients. In contrast, the typical FIR filters employ a sharing method by which common subexpressions are detected in the coefficients and shared, as common subexpressions are not created by symmetry of the coefficients. Both the typical and linear phase methods share the concept that common subexpressions are included in filter coefficients.

In FIR filter design using the canonical signed digit (“CSD”) method, a common subexpression sharing method for reducing the number of adders being used has been being disclosed in the current field under the title of “Subexpression sharing”. For example, a paper by Richard I. Hartley discloses “Subexpression sharing in filters using canonic signed digit multipliers” (IEEE Transactions on Circuits and Systems II: Analog and digital signal processing, Vol. 43, No. 10, pp. 677-688, October 1996).

In addition, a high-speed FIR digital filter structure and a filter design method were disclosed by M. Yagyu, A. Nishihara, and N. Fujii, under the title of “Fast FIR digital filter structures using minimal number of adders and its application to filter design” (IEICE Transactions on Fundamentals, Vol. E79 A, No. 8, pp. 1120-1129, August 1996).

The adders in the filter configurations as disclosed in the art references can be somewhat reduced in number by using common subexpressions that are created with symmetry of the linear phase filter coefficients. However, there remains a problem that the number of adders cannot be reduced as much as that desired for high-speed and low-power semiconductor chip designs. Thus, a new method is desired for decreasing the number of additions in such subexpressions in order to design a low-power and high-speed filter of the CSD type.

As described above, the conventional art techniques have a problem that a high-speed and low-power designs are difficult to obtain because large numbers of adders are used therein. In digital filters that are designed using the CSD method where the number of adders serves to define a semiconductor design size and/or a process speed, improved techniques for minimizing the number of adders are needed.

### SUMMARY OF THE INVENTION

These and other drawbacks and disadvantages of the prior art are addressed by a system and method for digital filtering that includes a method for implementing a digital filter having filter coefficients, each expressible as a canonical signed digit code word; where the method includes forming a virtual common subexpression that is relevant to a first filter coefficient, forming a second subexpression for a second filter coefficient in terms of the virtual common subexpression so that adders are shared with the virtual common subexpression in a tap line of the second filter coefficients; and the resulting digital filter receives digital samples of input signals, shifts the received digital samples by bit-shift values of filter coefficients that are defined relative to the virtual common subexpression, adds shifted digital samples to drive a common tap line, adds shifted digital samples to the output of the common tap line to drive a tap line corresponding to a filter coefficient, and delays an output signal component corresponding to a tap line.

These and other aspects, features and advantages of the present disclosure will become apparent from the following description of exemplary embodiments, which is to be read in connection with the accompanying drawings.

### BRIEF DESCRIPTION OF THE DRAWINGS

The foregoing and other objects, aspects and advantages of the present disclosure will be better understood from the following detailed description of preferred embodiments of the disclosure with reference to the drawings, in which;

FIG. 1 is a structural view showing a canonical signed digit (“CSD”) linear phase filter structure using a conventional common subexpression;

FIG. 2 is a structural view showing a CSD linear phase filter structure using a conventional common subexpression;

FIG. 3 is a structural view showing a CSD linear phase filter structure using a conventional common subexpression;

FIG. 4 is a structural view showing an improved CSD linear phase filter structure according to an embodiment of the present disclosure;

FIG. 5 is a structural view showing an improved CSD linear phase filter structure according to another embodiment of the present disclosure;

FIG. 6 is a structural view showing an improved CSD linear phase filter structure according to another embodiment of the present disclosure;

FIG. 7 is a block diagram of an intermediate frequency (“IF”) digital signal processing part of a wireless receiver terminal to which embodiments of the present disclosure can be applied;

FIG. 8 shows a structural view of filter subexpressions using virtual common subexpressions according to an embodiment of the present disclosure; and

FIG. 9 shows a structural view of filter subexpressions using conventional common subexpressions.

### DETAILED DESCRIPTION OF THE PREFERRED EMBODIMENTS

In the following description, like reference numerals are used to denote like or equivalent elements or features in the several figures. In addition, exemplary specifications are disclosed to provide a thorough understanding of the present disclosure, although it shall be readily apparent to one of ordinary skill in the pertinent art that a working knowledge of the teachings of the present disclosure can be achieved without the particular exemplary specifications disclosed herein. A detailed description of well-known functions and structures will be omitted so as to emphasize several key points of the present disclosure.

One feature or technical sprite of the present disclosure that will be described herein is that symmetry of filter coefficients or any random subexpressions that do not appear as 2's complement can be designed by using a virtual common subexpression. For example, if a common subexpression is bit-shifted, bit-added, or bit-inverted, it can be changed into an artificial subexpression, which is named a virtual common subexpression in the present disclosure. Accordingly, the term “virtual common subexpression” means a subexpression, which is originally not a common subexpression, designed and changed into a common subexpression by using an existing common subexpression.

Adders being used in the present disclosure all full adders having a plurality of input terminals, except in exceptional cases in which the adder is used for an early input. The full adder may comprise two half adders and one OR gate. The half adder typically comprises one exclusive OR gate and one AND gate connected thereto. A delayer may comprise a flip-flop or register.

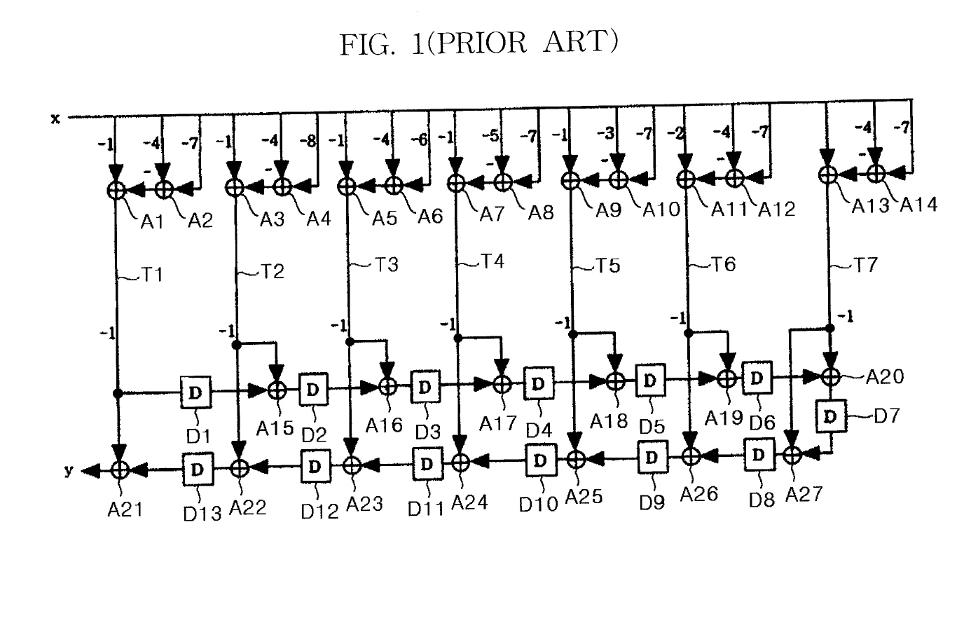

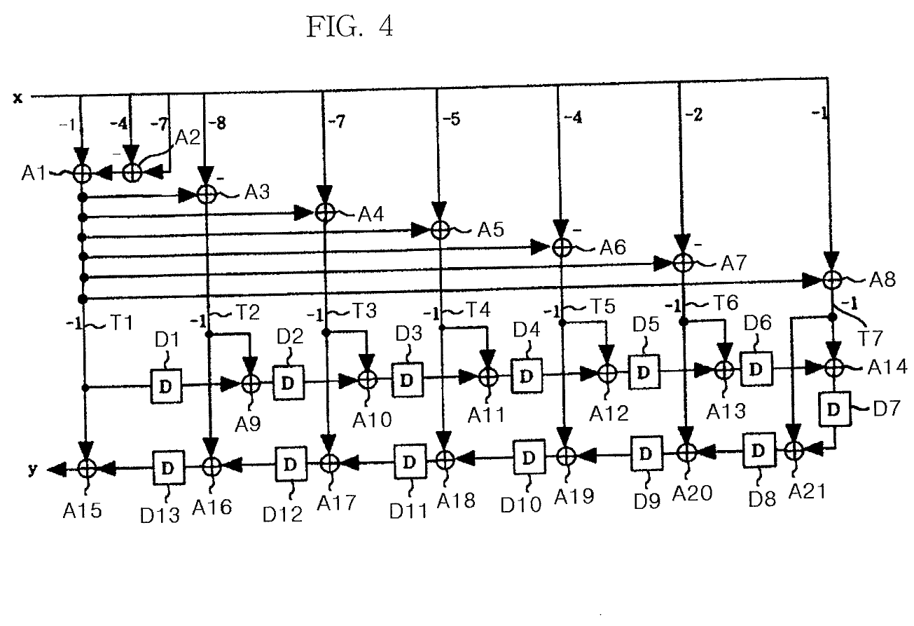

First, the creation of a virtual common subexpression by bit-shift operation will be explained below. Before or after the explanation, FIG. 4 may be compared with FIG. 1 to count the reduction in the number of adders.

The following linear phase FIR filter of 14 taps is considered:

H(z)=h₀+h₁z⁻¹+h₂z⁻²+h₃z⁻³+h₄z⁻⁴+h₅z⁻⁵+h₆z⁻⁶+h₇z⁻⁸h₈z⁻⁸+h₉z⁻⁹+h₁₀z^{-z}+h₁₁z⁻¹¹+h₁₂z⁻¹²h₁₃z⁻¹³

The above filter coefficients are expressed by the same CSD type as in Table 1.

Accordingly, the coefficient subexpressions in Table 1 can be expressed by the following equations using h0.

h1:0100N0001=0100N0010−000000001

h2:0100N0100=0100N0010+000000010

h3:01000N010=0100N0010+000001000

h4:010N00010=0100N0010−000010000

h5:0010N0010=0100N0010−001000000

h6:1000N0010=0100N0010+010000000

That is, all the subexpressions may be expressed using a subexpression of 0100N0010, which is a common subexpression h0. Therefore, the coefficient subexpressions as described above may be expressed by mathematical formulas as follows:

h₀:x₂=x₁−x₁>>3+x₁>>6

h₁:x₃=x₂−x₁>>7

h₂:x₄=x₂+x₁>>6

h₃:x₅=x₂+x₁>>4

h₄:x₆=x₂−x₁>>3

h₅:x₇=x₂−x₁>>1

h₆:x₈=x₂+x₁

An output signal may be expressed by using the above subexpressions as follows:

y=x₂>>1+x₃[−1]>>1+x₄[−2]>>1+x₅[−3]>>1 +x₆[−4]>>1+x₇[−5]>>1+x₈[−6]>>1+ symmetry

If the FIR filter having coefficient subexpressions as described above is designed by using a transposed direct form, the configuration shown in FIG. 4 is obtained.

In FIG. 4, the lines T1˜T7 indicate taps, the adders are designated as the symbols Ai (i indicate natural numbers more than 0, the delayers as Di, the input signal as x, and the output signal as y, respectively. In the figure, the subtracter for performing subtraction is expressed by an adder, but the input terminal of the subtracter is designated by the symbol “−”.

Referring to FIG. 4, the adders A1 and A2 shown in the tap line T1 perform additions of −1, −4, −7 and implement the coefficient h0, and the adder A3 shown in the tap line T2 performs addition of −8 and the coefficient h0 and implements the coefficient h1. The adder A4 shown in the tap line T3 performs addition of −7 and the coefficient h0 to implement the coefficient h2. The adder A5 shown in the tap line T4 performs addition of −5 and the coefficient h0 to implement the coefficient h3. The adder A6 shown in the tap line T5 performs addition of −4 and the coefficient h0 to implement the coefficient h4. The adder A7 shown in the tap line T6 performs addition of −2 and the coefficient h0 to thereby implement the coefficient h5. The adder A8 shown in the tap line T7 performs addition of −1 and the coefficient h0 to thereby implement the coefficient h6. In these cases, it should be noted that the one-side terminals of the adders A3, A4, A5, A6, A7 and A8 are commonly connected to the tap line T1 of the filter coefficient h0 that operates as a common subexpression. The delayers D1 to D13 delay the outputs of the corresponding adders by a predetermined time in order to obtain the output signal y. For example, the delay D1 has been storing the output of the adder A1 and provides it to an input of the adder A9 at the time that the output of the adder A3 is output. The delay D2 provides an input of the adder A10 with the output of the adder A9 stored when the output of the adder A4 is output.

The number of adders that are used to design the filter shown in FIG. 4 is follows:

The 8 adders A1 through A8 are used to implement the filter coefficients and the 13 adders A9 to A21, which perform addition of the output delayed by the delayers with the output in the tap lines, are used to obtain the output signal y. Accordingly, the total number of adders used is 8+13=21. In this way, if the virtual common subexpression is created by bit shift to construct the filter as shown in FIG. 4, 6 adders can be deleted relative to the conventional configuration shown in FIG. 1. That is, 27 adders are used in the conventional configuration shown in FIG. 1, while in contrast, only 21 adders are used in the present configuration as shown in FIG. 4.

The reason the number of the adders was reduced, as described above, is that in the conventional method, since the filter coefficients of h1 through h6 are not relevant to the common subexpression of h0, the filter coefficients of h1 through h6 cannot be designed by using the common subexpression of h0, but must be designed by themselves, in contrast, in the present disclosure, all the random subexpressions to be designed, e.g., the filter coefficients of h1 through h6, can be expressed by using the filter coefficient of h0, unlike the conventional method.

That is, it is a new technique to change random subexpressions into virtual common subexpressions through 1-bit shift of the existing common subexpression. As shown in the above formula, all the filter coefficients of h1 through h6 can be expressed by adding one adder to a common subexpression of x2.

Therefore, in a digital filter having a plurality of filter coefficients that are expressed as CSD code words, the presently disclosed filter coefficient design method comprises designing the code word subexpressions for random filter coefficients out of the filter coefficients through the bit shift of the existing common subexpression. Accordingly, addition is performed through sharing the common subexpression in the tap lines of the random filter coefficients.

In the case of the first embodiment of the present disclosure as described above, it is shown that the number of adders being used in filter design is reduced by 6, by creating a virtual common subexpression through the bit shift when compared with the configuration in FIG. 1, thereby achieving low-power and high-speed processing as well as reduction of the number of adders.

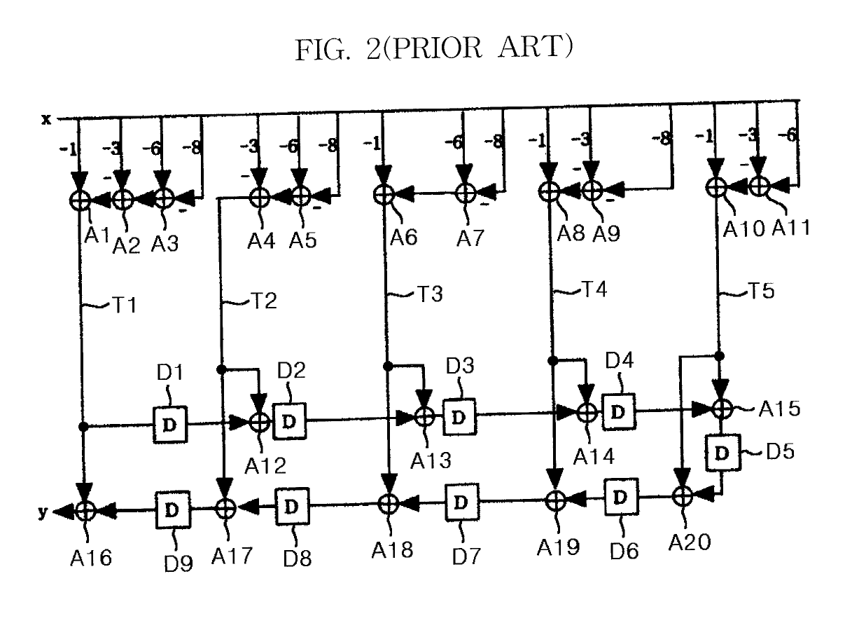

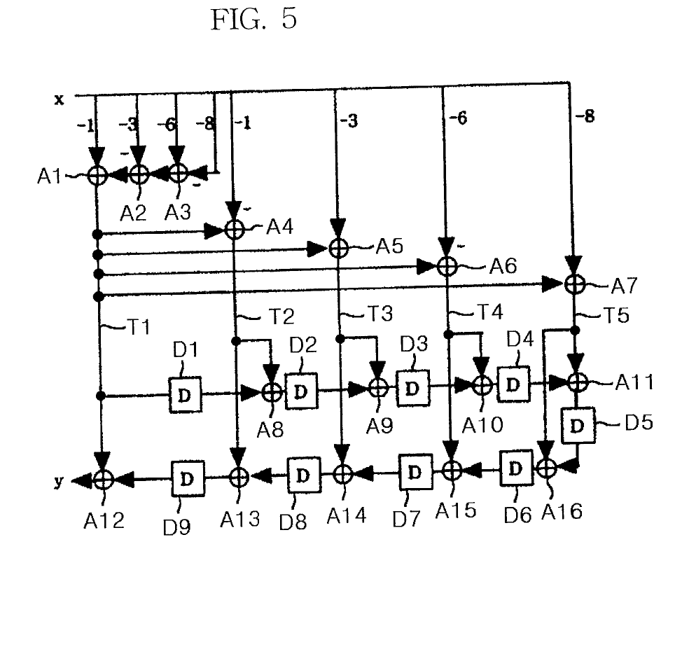

As a second case, generation of a virtual common subexpression through a bit add will be explained below. As realized in the first embodiment, it may also be seen that a reduction of the number of adders is achieved in the embodiment of FIG. 5 versus the conventional filter of FIG. 2, prior to consideration of the following enabling description.

Consideration is made of a linear phase FIR filter having 10 taps, as follows:

H(z)=h₀+h₁z⁻¹+h₂z⁻²+h₃z⁻³+h₄z⁻⁴+h₅z⁻⁵+h₆z⁻⁶+h₇z⁻⁸h₈z⁻⁸+h₉z⁻⁹

The above-filter coefficients may be expressed by CSD type coefficients as described in Table 2.

Each of the subexpressions in Table 2 may be expressed by using h0 as follows:

h1:00N0010N=10N0010N−10000000

h2:1000010N=10N0010N+00100000

h3:10N0000N=10N0010N−00000100

h4:10N00100=10N0010N+00000001

That is, all the subexpressions can be expressed by using the h0 subexpression as follows:

h₀:x₂=x₁−x₁>>2+x₁>>4−x₁>>7

h₁:x₃=x₂−x₁

h₂:x₄=x₂+x₁>>2

h₃:x₅=x₂−x₁>>5

h₄:x₆=x₂+x₁>>7

The output signal may be designated by using the above subexpression as follows:

y=x₂+x₃[−1]+x₄[−2]x₅[−3]+x₆[−4]+ symmetry

If the FIR filter having coefficient subexpressions as described above is designed by using a transposed direct form, the configuration as shown in FIG. 5 is obtained.

In FIG. 5, the lines T1˜T5 indicate taps, the adders are designated as the symbols Ai (i indicate natural numbers more than 0), the delayers as Di, the input signal as x, and the output signal as y, respectively. In the figure, the subtracters for performing subtraction are expressed by adders, but the input terminals of the subtracters are designated by the symbol “−”.

Referring to FIG. 5, the adders Al, A2 and A3 shown in the tap line T1 perform additions of −1, −3, −6 and −8 to implement the coefficient h0, and the adder A4 shown in the tap line T2 performs addition of −1 and the coefficient h0 to implement the coefficient h1. The adder A5 shown in the tap line T3 performs addition of −3 and the coefficient h0 to implement the coefficient h2. The adder A6 shown in the tap line T4 performs addition of −6 and the coefficient h0 to implement the coefficient h3. The adder A7 shown in the tap line T5 performs addition of −8 and the coefficient h0 to implement the coefficient h4.

The delayers D1 to D9 delay the outputs of the corresponding adders by a predetermined time in order to obtain the output signal y. For example, the delay D1 has been storing the output of the adder A1 and provides it to an input of the adder A8 at the time the output of the adder A4 is output. The delay D2 provides an input of the adder A9 with the output of the adder A8 stored when the output of the adder A4 is output. In these cases, it should be noted that the one-side terminals of the adders A4, A5, A6, A7 are commonly connected to the tap line T1 of the filter coefficient h0 that operates as a common subexpression.

The number of adders that are used to design the filter shown in FIG. 5 is as follows:

The total of 7 adders, A1 through A7, are used to implement each of the filter coefficients because 3 adders, 1 adder, 1 adder, 1 adder and 1 adder are used for the coefficients. The total of 9 adders, A8 to A16, are used to obtain the output signal. Accordingly, the total number of adders used is 7+9=16. In this way, if the virtual common subexpression is created by bit adds to construct the filter as shown in FIG. 5, 4 adders can be eliminated relative to the conventional configuration shown in FIG. 2. That is, 20 adders are used in the conventional configuration shown in FIG. 2, while in contrast, only 16 adders are used in the present configuration shown in FIG. 5.

The reason the number of the adders was reduced, as described above, is that in the conventional method, since the filter coefficients of h1 through h4 are not relevant to the common subexpression of h0, the filter coefficients of h1 through h4 cannot be designed by using the common subexpression of h0, but must be designed individually, while in contrast, in the present disclosure, all the random subexpressions to be designed, e.g., the filter coefficients of h1 through h4, can be expressed by using the filter coefficient of h0, unlike the conventional method.

That is, it is a new technique to change random subexpressions into virtual common subexpressions through 1-bit adds of the existing common subexpression. As shown in the above formula, all the filter coefficients of h1 through h4 can be expressed just by adding one adder to a common subexpression of x2.

In the case of the second embodiment of the present disclosure as described above, it is shown that the number of adders being used in filter design is reduced by 4, by creating a virtual common subexpression through the bit add when compared with the configuration in FIG. 2, thereby achieving low-power and high-speed processing as well as a reduction of the number of adders.

As a third embodiment of the present disclosure, the creation of a virtual common subexpression through the bit inversion will be explained below.

A linear phase FIR filter having 10 taps is considered as follows:

H(z)=h₀+h₁z⁻¹+h₂z⁻²+h₃z⁻³+h₄z⁻⁴+h₅z⁻⁵+h₆z⁻⁶+h₇z⁻⁸h₈z⁻⁸+h₉z⁻⁹

The above-filter coefficients may be expressed by CSD expressions as described in Table 3. In the Table 3, the rows indicate filter coefficients of one CSD type expressed by 9 bits and the columns indicate the various coefficients used. That is, the coefficient of h0 is 10N0010N0 as a CSD type.

Each of the subexpressions in Table 3 may be expressed by using h0 as follows:

h1:N0N0010N0=10N0010N0−100000000

h2:1010010N0=10N0010N0+010000000

h3:10 N00N0N0=10N0010N0−000010000

h4:10N001010=10 N0010N0+00000010

That is, all the subexpressions can be expressed using h0 as a common subexpression, as follows:

h₀:x₂=x₁−x₁>>2+x₁>>5−x₁>>7

h₁:x₃=x₂−x>(−1)

h₂:x₄=x₂+x>>1

h₃:x₅=x₂−x>>4

h₄:x₆=x₂+x>>6

The output signal may be expressed using the above-expressions as follows:

y=x₂+x₃[−1]+x₄[−2]+x₅[−3]+x₆[−4]+symmetry

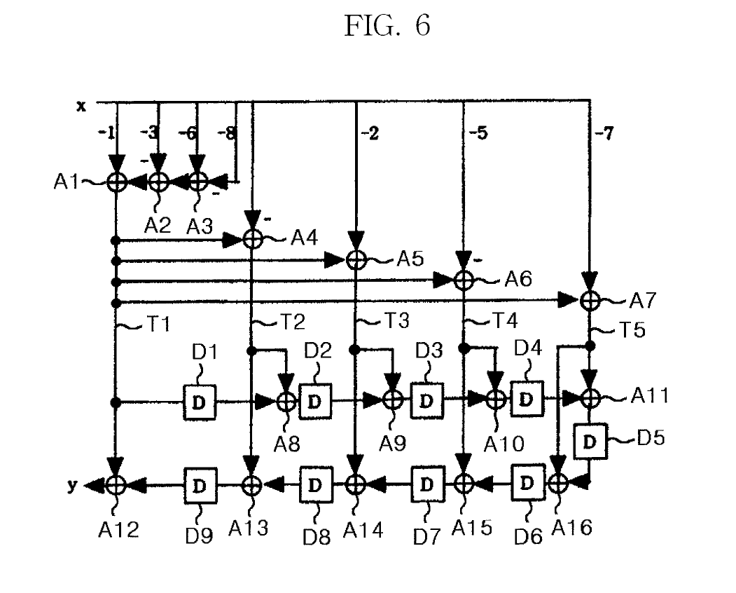

If the FIR filter having coefficient subexpressions as described above is designed by using a transposed direct form, the configuration as shown in FIG. 6 is obtained.

In FIG. 6, the lines T1˜T5 indicate taps, the adders are designated as the symbols Ai (i indicate natural numbers more than 0), the delayers as Di, the input signal as x, and the output signal as y, respectively. In the drawing, the subtracters for performing subtraction are expressed by adders, but the input terminals of the subtracters are designated by the symbol “−”.

Referring to FIG. 6, the adders A1, A2 and A3 shown in the tap line T1 perform additions of −1, −3, −6 and −8 to implement the coefficient h0, and the adder A4 shown in the tap line T2 performs addition of an input signal and the coefficient h0 to implement the coefficient h1. The adder A5 shown in the tap line T3 performs addition of −2 and the coefficient h0 to implement the coefficient h2. The adder A6 shown in the tap line T4 performs addition of −5 and the coefficient h0 to implement the coefficient h3. The adder A7 shown in the tap line T5 performs addition of −7 and the coefficient h0 to implement the coefficient h4.

The delayers D1 to D9 delay the outputs of the corresponding adders by a predetermined time in order to obtain the output signal y. For example, the delay D1 has been storing the output of the adder A1 and provides it to an input of the adder A8 at the time the output of the adder A4 is output. The delay D2 provides an input of the adder A9 with the output of the adder A8 stored when the output of the adder A5 is output. In these cases, it should be noted that the one-side terminals of the adders A4, A5, A6 and A7 are commonly connected to the tap line T1 of the filter coefficient h0 that operates as a common subexpression.

The number of adders that are used to design the filter shown in FIG. 6 is follows:

The total of 7 adders Al through A7 are used to design each of the filter coefficients because 3 adders, 1 adder, 1 adder, 1 adder and 1 adder are used for the coefficients. The 9 adders A8 to A16 are used to obtain the output signal. Accordingly, the total number of adders used is 7+9=16.

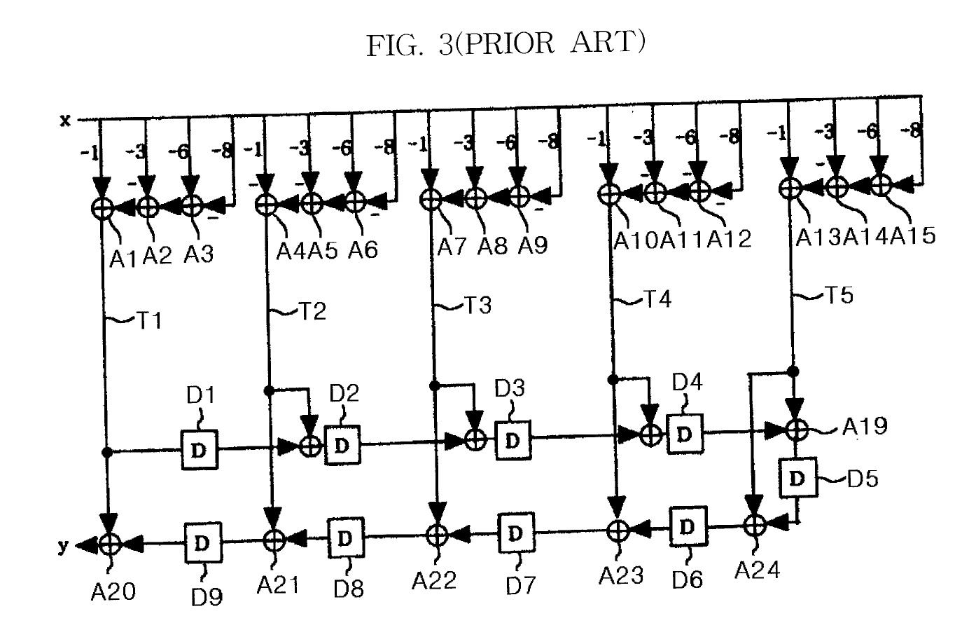

In this way, if the virtual common subexpression is created by bit inversion to construct the filter as shown in FIG. 6, 8 adders can be eliminated relative to the conventional configuration shown in FIG. 3. That is, 24 adders are used in the conventional configuration shown in FIG. 3, while in contrast, only 16 adders are used in the configuration shown in FIG. 6.

The reason the number of the adders was reduced, as described above, is that in the conventional method, since the filter coefficients of h1 through h4 are not relevant to the common subexpression of h0, the filter coefficients of h1 through h4 cannot be designed by using the common subexpression of h0, but must be designed by themselves, while in contrast, in the present disclosure, all the random subexpressions to be designed, e.g., the filter coefficients of h1 through h4, can be expressed by using only the filter coefficient h0, unlike the conventional method.

That is, the filter is designed by defining subexpressions that are identical to the 1-bit-inverted common subexpression as a virtual common subexpression and using the virtual common subexpression. As shown in the formula, all the filter coefficients of h1 through h4 are expressed by adding one adder to the common subexpression of x2.

In the case of the third embodiment of the present disclosure as described above, it is shown that the number of adders being used in filter design is reduced by 8 when compared with the configuration in FIG. 3. Therefore, by creating a virtual common subexpression through the bit inversion, low-power and high-speed processing as well as a reduction of the number of adders is achieved.

As described above, if filters are designed by creating a virtual common subexpression through the bit shift, bit add, and/or bit inversion for any random subexpressions, reduction of the number of adders can be remarkably reduced compared with conventional methods.

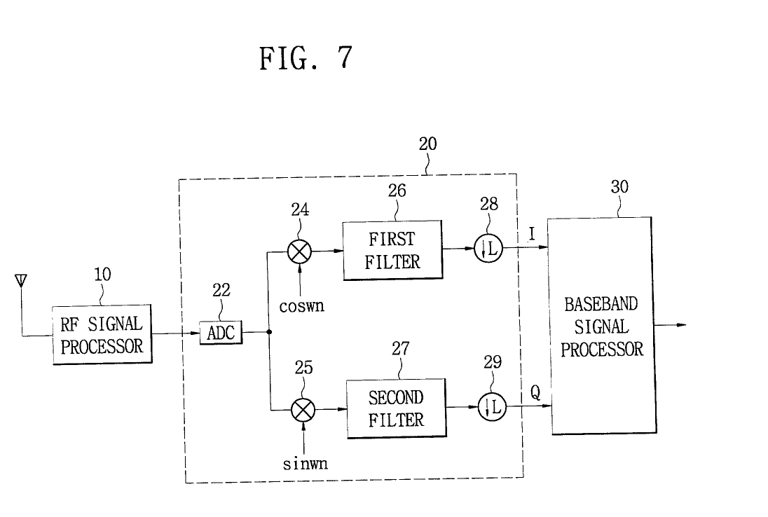

In the case where the above-described architectures are applied to a system shown in FIG. 7, reduction of the number of adders through the creation of a virtual common subexpression is explained below.

In FIG. 7, an analog signal that is received through the RF signal processor 10 is changed into a digital sample of predetermined bit by the analog to digital converter (ADC) 22 and provided to the first and second multipliers 24, 25. The first and second filters 26, 27 perform filtering with a given specification to output the separately filtered signals I, Q to the signal processor 30. In FIG. 7, when digital filters such as, for example, the first filters 26, 27, with the IF terminal specification of CDMA cellular phone systems are manufactured by CSD architecture techniques, sampling frequency of the filter is predetermined by 19.6608MHz, pass band frequency by 630 KHz, pass band ripple by 0.1 dB, stop band frequency by 1.2288MHz, and stop band attenuation by −40dB.

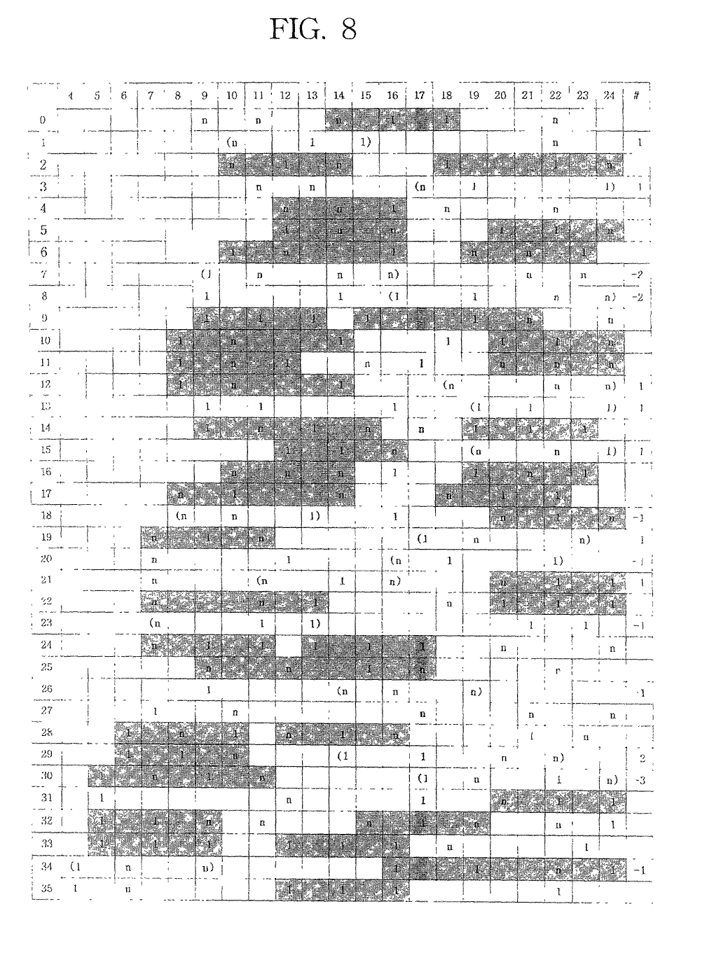

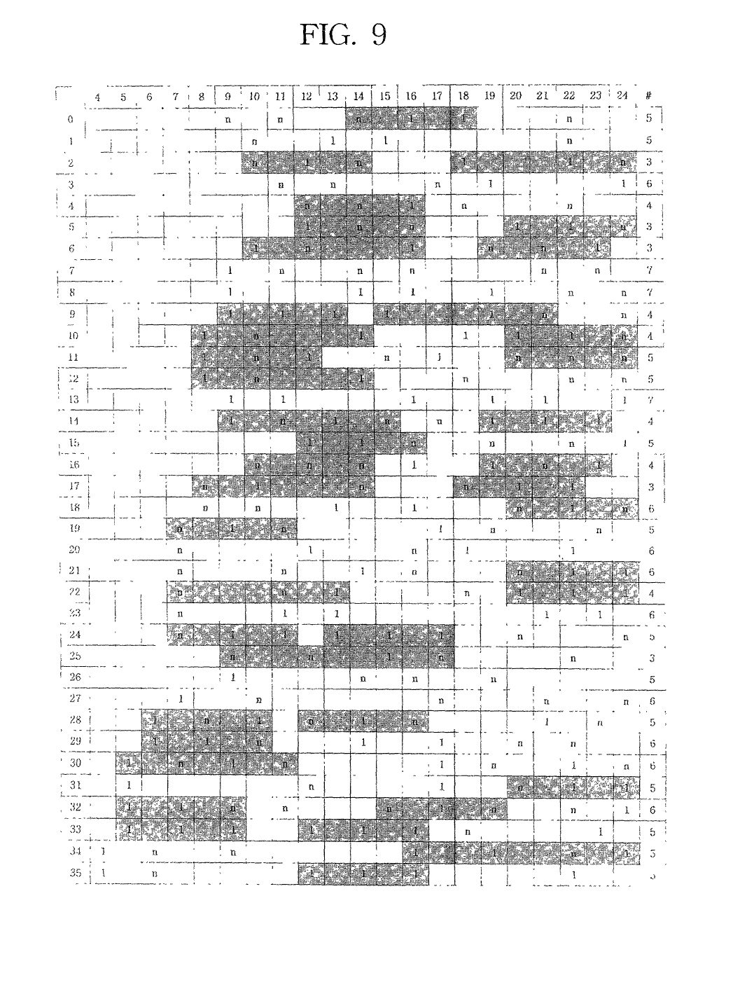

Turning now to FIGS. 8 and 9, a linear phase FIR filter of 72 taps with the above specification is explained below.

Since the 72 filter coefficients are symmetrical, 36 filter coefficients need only be expressed, as shown in FIG. 9, according to a conventional common subexpression. This is contrasted with the case where the filter is expressed by CSD type coefficients of 24-bit precision, but expressed as shown in FIG. 8 according to a virtual common subexpression of the present disclosure. In FIG. 8 and FIG. 9, “−1” is designated by “n”.

In FIG. 9, since the total number of 1s or −1s is m=458, m−1=457 adders are needed when common subexpressions are not used. If only conventional common subexpressions are used through linear phase symmetry, 229−1+36=264 adders are needed. However, if the filter is designed by sharing common subexpressions according to a conventional method wherein only 179 adders are needed to implement the tap coefficients and 17 adders are needed to implement the output coefficients, 179+18−1=196 total adders are required as shown in FIG. 9. As also shown in FIG. 9, the common subexpressions are expressed with black-colored blocks and the numbers of adders (#) for designing the filter coefficients are indicated in a column direction in the right side of FIG. 9. Thus, FIG. 9 shows a common subexpression implementation requiring a total of 196 adders.

FIG. 8 shows a virtual common subexpression embodiment of the present disclosure with the number of adders saved as compared with the conventional filter of FIG. 9 indicated in the “#” column, as follows:

h1*00101=*0101's bit shift (−1)

h3:*0100001=*0100*01's bit add (−1)

h7:10*00*0*=10*0010*'s bit inversion(−2)

h8:100100*0*=100100*01's bit inversion(−2)

h12:*000*0*=*000*01's bit inversion(−1)

h13:101001=10101's bit shift(−1)

h15:*00*01=*0*01's bit shift(−1)

h18:*0*001=*0*01 's bit shift(−1)

h19:10*000*=10*010*'s bit add(−1)

h20:*010001=*010*01's bit add(−1)

h21:*0010*=*010*'s bit shift(−1)

h23:*000101=*000*01's bit inversion(−1)

h26:*0*00*=*0*0*'s bit shift(−1)

h29:100100*0*=100100*01's bit inversion(−2)

h30:10*0010*=newly defined common subexpression(−3)

h34:10*00*=10*0*'s bit shift(−1)

Thus, the number of adders required to implement the tap coefficients by the virtual common subexpression embodiment of FIG. 8 is 21 adders fewer than required for the more conventional filter of FIG. 9.

As shown in FIG. 8, a reduction of 21 adders is achieved in the 16 coefficients out of the total of 36 coefficients, which are indicated by parenthesis as shown in FIG. 8. In addition, the reduced number of adders relative to FIG. 9 is shown in a column direction in the right side of FIG. 8, and the sum of the reduced number of adders to implement the tap coefficients is 158. Accordingly, as 21 adders are required to make a common subexpression in this application example, the total number of required adders is 21+158=178.

As a result, referring to FIGS. 8 and 9, it is shown that the total number of adders is reduced is reduced by 196−178=18 when compared with the conventional common subexpression method.

TABLE 4

| | The number of | |
|---|---|---|
| Method | adders | % |
| Direct design (m = 458) | 457 | 233.2 |
| Coefficient symmetry | 264 | 134.7 |
| Conventional common subexpression (FIG. 9) | 196 | 100 |
| Virtual common subexpression (FIG. 8) | 178 | 90.8 |

As described above, when the IF filter of the CDMA cellular phone system terminal is designed according to the presently disclosed architecture, a 9.2% reduction in the number of adders is achieved compared with the CSD architecture that uses the conventional common subexpression method.

The virtual common subexpression architecture of the present disclosure may be used in other types of filters as well as in the linear phase FIR filters. In the foregoing, the present disclosure was described with reference to exemplary embodiments and the accompanying drawings. However, it is to be understood that the teachings of the present disclosure are not limited to the described embodiments or illustrations and may be changed, adapted or modified by a person of ordinary skill in the pertinent art. For example, the number of filter taps, the common subexpression creation and the virtual common subexpression creation through bit-shift, bit-add and bit-inversion can be changed or modified in response to design objectives. In addition, filters may be designed by realizing shift registers, adders, delayers and the like with software through a digital signal processor or microprocessor, in addition to or as an alternative to hardware.

Accordingly, an advantage of the present disclosure using a virtual common subexpression provides a low-power CSD linear phase filter structure. Another advantage provides a filter design method by which the number of adding operations can be minimized. A further advantage provides a FIR filter having high-speed operation. An additional advantage provides a digital filter of low-power and high-speed operation and a filter design method by which area occupied by a corresponding circuit implemented in a semiconductor chip can be minimized with a corresponding reduction in manufacturing costs.

It is to be understood that the teachings of the present disclosure may be implemented in various forms of hardware, software, firmware, special purpose processors, or combinations thereof. Most preferably, the teachings of the present disclosure are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O ”) interfaces. The computer platform may also include an operating system and microinstruction code. The various processes and functions described herein may be either part of the microinstruction code or part of the application program, or any combination thereof, which is executed via the operating system. In addition, various other peripheral units may be connected to the computer platform such as an additional data storage unit and a printing unit.

It is to be further understood that, because some of the constituent system components and method function blocks depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be affected therein by one of ordinary skill in the pertinent art without departing from the scope or spirit of the present disclosure. All such changes and modifications are intended to be included within the scope of the present disclosure as set forth in the appended claims.

What is claimed is:

1. A filter coefficient design method in a digital filter having a plurality of filter coefficients that are expressed with CSD code words of n bits (n: natural number more than 2), comprising the step of: making code word subexpression for random filter coefficients out of the filter coefficients as a virtual common subexpression that is relevant to a predetermined common subexpression so that adders are shared with the common subexpression in tap lines of the random filter coefficients.

2. The method of claim 1, wherein the virtual common subexpression becomes identical to the common subexpression through bit-shift.

3. The method of claim 1, wherein the virtual common subexpression becomes identical to the common subexpression through bit-add.

4. The method of claim 1, wherein the virtual common subexpression becomes identical to the common subexpression through bit-inversion.

5. The method of claim 1, wherein the virtual common subexpression becomes identical to the common subexpression through at least two more processes out of bit-shift, bit-add and bit-inversion.

6. The method of claim 1, wherein the digital filter is a linear phase FIR filter.

7. A method for receiving and filtering input signals of digital samples of k bits (k: natural numbers more than 4) in a digital filter having filter characteristics that are created by filter coefficients being expressed as CSD code words of n bits (n: natural numbers more than 2), comprising the steps:
creating as a virtual common subexpression common subexpressions created by bit-shift, bit-add, or bit-inversion of random coefficient subexpressions out of the digital filter coefficients, thereafter shifting the digital samples by the number of bits corresponding to the common subexpression and the virtual common subexpression;
adding up all the digital samples shifted by the number of bits corresponding to the common subexpressions to obtain a composite output value of a common coefficient tap line;
obtaining composite output values of random coefficient tap lines by adding up the digital samples shifted by the number of bits corresponding to the virtual common subexpression and the composite output value of the common coefficient tap line being used as a common input; and
performing in order delaying and adding to create filter output values by subsequent compositions of the composite output values of the common coefficient tap lines and the composite output values of the random coefficient tap lines.

8. The method of claim 7, wherein the number of the tap lines is set as 73 in case where the digital filter is used in a middle frequency terminal of a mobile radio communication system.

9. The method of claim 8, wherein the number of bits of the CDS code word is 24 bits.

10. A digital filter, comprising:
a shift register group including first shift register members each receiving digital samples of k bits as input signals and shifting the received digital samples by bit shift values of filter coefficients that are defined as common subexpressions out of filter coefficients that are expressed as code words of n bits within CSD code, and second shift register members shifting code words of the other filter coefficients that are not defined as the common subexpressions by using the code words of the common subexpressions;
a adder group including first composite members adding up the shifted digital samples that are output from the first shift register members to provide them to common tap lines, and second composite members for adding the shifted digital samples that are output from the second shift register members to the composite outputs of the common tap lines to provide the results to each of corresponding tap lines;
a delay group including a plurality of delayers connected to the tap lines and being connected in series from one another to provide delay to the composite outputs; and
an output adder group including a plurality of adders for adding up the outputs of the delayers and the composite outputs of the tap lines to create digital output signals of k bit(s).

11. An N tap CSD digital filter having filter coefficients that are expressed as CSD codes, comprising:
a shift register group including first shift register members receiving digital samples of a plurality of bits as input signals and shifting the received digital samples by bit shift values of filter coefficients that are defined as common subexpressions out of the filter coefficients, and second shift register members shifting code words of the other filter coefficients that are not defined as the common subexpressions by using the code words of the common subexpressions;
an adder group including first composite members adding up the shifted digital samples that are output from the first shift register members to provide them to common tap lines, and second composite members for adding the shifted digital samples that are output from the second shift register members to the composite outputs of the common tap lines to provide the results to each of the corresponding tap lines;
a delay group including a plurality of delayers connected to the tap lines and being connected in series from one another to provide delay to the composite outputs; and
an output adder group including a plurality of adders for adding up the outputs of the delayers and the composite outputs of the tap lines to create digital output signals of k bit(s).

12. The digital filter of claim 11, wherein the common tap line is a tap line of filter coefficients having the greatest number of common coefficient subexpressions out of the filter coefficients.

13. The digital filter of claim 11, wherein the digital filter is designed with software by a digital signal processor performing shifting, adding, and delaying.

14. A method for implementing a digital filter having a plurality of filter coefficients, each expressible as a canonical signed digit code word, the method comprising:
forming a virtual common subexpression that is relevant to a first of the plurality of filter coefficients;
forming at least a second subexpression for at least a second of the plurality of filter coefficients in terms of the virtual common subexpression so that adders are shared with the virtual common subexpression in a tap line of at least the second of the plurality of filter coefficients.

15. A method as defined in claim 14 wherein at least the second subexpression is formed from the virtual common subexpression through at least one of a bit-shift, a bit-add and a bit-inversion.

16. A method as defined in claim 14 wherein each of the plurality of filter coefficients is formed from the virtual common subexpression through at least one of a bit-shift, a bit-add and a bit-inversion.

17. A program storage device readable by a machine, tangibly embodying a program of instructions executable by the machine to perform method steps for implementing a digital filter having a plurality of filter coefficients, each coefficient expressible as a canonical signed digit code word, the method steps comprising:
forming a virtual common subexpression that is relevant to a first of the plurality of filter coefficients;
forming at least a second subexpression for at least a second of the plurality of filter coefficients in terms of the virtual common subexpression so that adders are shared with the virtual common subexpression in a tap line of at least the second of the plurality of filter coefficients.

18. A system for implementing a digital filter having a plurality of filter coefficients, each expressible as a canonical signed digit code word, the system comprising:
means for forming a virtual common subexpression that is relevant to a first of the plurality of filter coefficients;
means for forming at least a second subexpression for at least a second of the plurality of filter coefficients in terms of the virtual common subexpression so that adders are shared with the virtual common subexpression in a tap line of at least the second of the plurality of filter coefficients.

19. A digital filter comprising:
at least one shift register for receiving digital samples of input signals and shifting the received digital samples by bit-shift values of filter coefficients that are defined relative to a virtual common subexpression;
a first adder for adding shifted digital samples that are output from the at least one shift register to drive a common tap line;
a second adder for adding shifted digital samples that are output from the at least one shift register to the output of the common tap line to drive a tap line corresponding to a filter coefficient; and
at least one delay unit connected to a tap line for delaying an output signal component.

20. A digital filter comprising:
means for receiving digital samples of input signals;
means for shifting the received digital samples by bit-shift values of filter coefficients that are defined relative to a virtual common subexpression;
means for adding shifted digital samples to drive a common tap line;
means for adding shifted digital samples to the output of the common tap line to drive a tap line corresponding to a filter coefficient; and
means for delaying an output signal component corresponding to a tap line.

21. A program storage device readable by a machine, tangibly embodying a program of instructions executable by the machine to perform method steps for digitally filtering input signals, the method steps comprising:
receiving digital samples of the input signals;
shifting the received digital samples by bit-shift values of filter coefficients that are defined relative to a virtual common subexpression;
adding shifted digital samples to drive a common tap line;
adding shifted digital samples to the output of the common tap line to drive a tap line corresponding to a filter coefficient; and
delaying an output signal component corresponding to at least one of a filter coefficient and a tap line.
